(19) United States
(12) Patent Application Publication
(10) Pub. No.: US 2025/0334334 A1
(43) Pub. Date: Oct. 30, 2025

(54) CONTINUOUS HEAT TREATMENT SYSTEM FOR HIGH-PRESSURE FLUID STORAGE CONTAINER

(71) Applicant: AETHER CT Co., LTD, Busan (KR)

(72) Inventors: Yongrok OH, Busan (KR); Gi Beom PARK, Changwon-si, Gyeongsangnam-do (KR); Seonghyeon YOON, Busan (KR); Hyun Joon JI, Busan (KR)

(73) Assignee: AETHER CT Co., LTD, Busan (KR)

(21) Appl. No.: 18/290,319

(22) PCT Filed: Jul. 14, 2023
(86) PCT No.: PCT/KR2023/010101

§ 371 Date: Dec. 6, 2024

(30) Foreign Application Priority Data
Dec. 1, 2022 (KR) 10-2022-0165528

(51) Int. Cl. F27B 9/24; F27B 9/04

(52) U.S. Cl. CPC F27B 9/2407; F27B 9/045

(57) ABSTRACT

A continuous heat treatment system for a high-pressure fluid storage container includes a heat treatment apparatus including a first transfer unit which transfers a high-pressure fluid storage container, in which a high-pressure fluid is stored, in a longitudinal direction through the heat treatment space and a heating unit which heats an interior of the heat treatment space to a predetermined heat treatment temperature atmosphere and a cooling apparatus including a second transfer unit which continuously transfers the high-pressure fluid storage container transferred from the first transfer unit in the longitudinal direction and in which a lifting part is formed in at least a partial section to be vertically moved in a state in which the high-pressure fluid storage container is held, a lifting driving unit which vertically moves the lifting part, and a cooling bath in which a cooling space for accommodating a cooling fluid is formed.

### TECHNICAL FIELD

The present invention relates to a continuous heat treatment system for a high-pressure fluid storage container, and more specifically, to a continuous heat treatment system for a high-pressure fluid storage container, which consecutively performs a heat treatment process and a cooling process without performing a process of moving a high-pressure fluid storage container to a separate location in a process of manufacturing the high-pressure fluid storage container.

### BACKGROUND ART

There are concerns about the depletion of fossil fuels, which have been conventionally used as main energy sources, over time, and human interest has been gradually shifting to alternative energy sources due to environmental pollution issues.

Among these alternative energy sources, hydrogen fuel is drawing attention, and since hydrogen is very abundant and there are no concerns about environmental pollution, the potential of hydrogen is very high.

In particular, vehicles that use hydrogen fuel are being studied as alternatives to vehicles that use conventional internal combustion engines, and the results thereof are appearing.

Accordingly, various studies on storage containers that are provided in vehicles and charging stations to safely store hydrogen gas filled at high pressure are also being actively carried out.

In general, a method of providing a pipe having a hollow therein, pressing the pipe while rotating the pipe through a spinning process to form an overall shape, and performing a quenching or tempering process is widely used to obtain physical characteristics of such a hydrogen storage container.

In this case, in the quenching or tempering process, a heat treatment process and a cooling process are repeatedly performed, and conventionally, a method of moving the hydrogen storage container from a heat treatment furnace to a cooling bath using a device such as a crane in order to perform the cooling process after the heat treatment process is completed.

Generally, since there is a difference in heat treatment quality according to the transfer time from the heat treatment furnace to the cooling bath, the conventional method has a problem that the product has large quality variations, and there is the possibility that an accident occurs during the transfer process.

Particularly, in the case of a very large storage container, an aspect ratio is high, making transfer using the crane or the like is difficult, in addition, since the storage container heated to 800° C. or more during heat treatment should be transported, a serious accident problem can be caused.

### DISCLOSURE OF THE INVENTION

### Technical Goals

The present invention is directed to providing a continuous heat treatment system capable of consecutively performing a heat treatment process and a cooling process without performing a process of moving a high-pressure fluid storage container to a separate location in a process of manufacturing the high-pressure fluid storage container.

Objectives of the present invention are not limited to the above-described objective, and other objectives which are not described above will be clearly understood by those skilled in the art through the following description.

### Technical Solutions

According to an aspect of the present invention, there is provided a continuous heat treatment system for a high-pressure fluid storage container, the continuous heat treatment system including a heat treatment apparatus including a first transfer unit which transfers a high-pressure fluid storage container, in which a high-pressure fluid is stored, in a longitudinal direction through the heat treatment space and a heating unit which heats an interior of the heat treatment space to a predetermined heat treatment temperature atmosphere and a cooling apparatus including a second transfer unit in which a lifting part is formed to continuously transfer the high-pressure fluid storage container transferred from the first transfer unit in the longitudinal direction, a lifting driving unit which vertically moves the lifting part, and a cooling bath in which a cooling space for accommodating a cooling fluid is formed and which is provided under the second transfer unit to cool the high-pressure fluid storage container located in the cooling space as the lifting part is lowered.

The heat treatment apparatus and the cooling apparatus may be provided as a plurality of treatment apparatuses and a plurality of cooling apparatuses, which are alternatively disposed.

The first transfer unit and the second transfer unit may include a plurality of transfer roller modules disposed along a transfer path of the high-pressure fluid storage container and driving motors which provide rotational driving forces to the transfer roller modules.

The driving motor of the first transfer unit and the driving motor of the second transfer unit may be synchronized with each other to control a speed.

The driving motor may be provided outside the heat treatment furnace, and the first transfer unit may further include a driving force transmission module which transmits the rotational driving force of the driving motor to the transfer roller module.

The transfer roller module may include driving bars rotated about a central axis by the rotational driving forces of the driving motor and a support roller which is provided to surround a circumference of the rotating bar, rotates with the rotating bar, and supports the high-pressure fluid storage container.

The support rollers may include a first support part which supports one eccentric side portion of the high-pressure fluid storage container and a second support part which is connected to the first support part and supports the other eccentric side portion of the high-pressure fluid storage container, wherein the first support part and the second support part may each be formed to have an inclined surface inclined downward toward a connection point thereof to form a recessed groove.

The support roller may be provided as a pair of support rollers on the rotating bar to have a line-symmetrical form and be spaced apart from each other.

The pair of support rollers may further include third support parts which protrude in opposite directions and support one eccentric side portion and the other eccentric side portion of a high-pressure fluid storage container having specifications different from those of the high-pressure fluid storage container supported by the first support parts and the second support parts.

The heat treatment apparatus may further include insulating units provided at an entrance and an exit of the heat treatment furnace to selectively block the entrance and exit of the heat treatment furnace.

The insulating unit may include an insulating door provided to selectively block the entrance and exit of the heat treatment furnace and a door lifting motor which provide driving forces for vertically moving the insulating doors;

The cooling apparatus may further include a chocking unit which blocks an open end of the high-pressure fluid storage container before the high-pressure fluid storage container located in the lifting part is lowered by the lifting part.

The chocking unit may include a blocking member which is provided to selectively block the open end of the high-pressure fluid storage container and in which an air path through air flows is formed, a rotational connecting member which is connected to the blocking member and rotates the blocking member along a circular trajectory about a rotation axis at a predetermined location, a rotary motor which provides a rotational driving force to the rotational connecting member, and an air injection module which prevents the cooling fluid from entering the high-pressure fluid storage container by injecting air into the air path of the blocking member.

The lifting driving unit may include a fixing frame provided above the lifting part, length adjusting modules provided under the fixing frame, connected to the lifting part, and whose length is variable, and a lifting driving motor which provides a driving force for adjusting the length of the length adjusting module.

The cooling apparatus may further include a circulation pump unit which circulates the cooling fluid accommodated in the cooling bath in a direction parallel to a transfer direction of the high-pressure fluid storage container.

### Advantageous Effects

According to a continuous heat treatment system for a high-pressure fluid storage container of the present invention for achieving the above objectives, since a high-pressure fluid storage container is transferred through a heat treatment furnace and a cooling bath in a process of continuously transferring the high-pressure fluid storage container using a first transfer unit and a second transfer unit, a heat treatment process and a cooling process can be consecutively performed, and thus there are advantages that an overall process time can be reduced and productivity can be greatly improved.

In addition, according to the present invention, quality variations can be minimized by greatly reducing a product processing waiting time, and an accident can be fundamentally prevented by omitting a process of moving a high-pressure fluid storage container to a separate location.

Effects of the present invention are not limited to the above-described effects and other effects, which are not described above, will be clearly understood by those skilled in the art from the appended claims.

### BRIEF DESCRIPTION OF DRAWINGS

FIG. 1 is a view illustrating an overall form of a continuous heat treatment system for a high-pressure fluid storage container according to one embodiment of the present invention;

FIGS. 2 to 5 are views illustrating forms and structures of components provided in a heat treatment apparatus in the continuous heat treatment system for a high-pressure fluid storage container according to one embodiment of the present invention; and

FIGS. 6 to 8 are views illustrating forms and structures of components provided in a cooling apparatus in the continuous heat treatment system for a high-pressure fluid storage container according to one embodiment of the present invention.

### BEST MODE FOR CARRYING OUT THE INVENTION

In the present specification, when a first component (region, layer, part, or the like) is described as being “disposed on,” “connected to,” or “coupled to” a second component, it means that the first component may be directly disposed on/connected to/coupled to the second component, or a third component may be interposed therebetween.

The same reference numeral refers to the same components. In addition, in the drawings, thicknesses, proportions, and dimensions of components are exaggerated for effective description of technical content.

The term “and/or” includes one or more combinations defined by related components.

Although terms such as “first,” “second,” and the like may be used for describing various components, the components are not limited by these terms. These terms are only used to distinguish one component from another component. Accordingly, a first component may be named a second component, and similarly, a second component may also be named a first component without departing from the scope of the present invention. The singular forms include the plural forms unless the context clearly indicates otherwise.

In addition, terms such as “below,” “under,” “above,” and “on,” are used to describe relationships between components illustrated in the drawings. The terms have relative concepts and are described based on directions illustrated in the drawings.

Unless otherwise defined, all terms (including technical and scientific terms) used in the present specification have the same meanings as generally understood by those skilled in the art to which the present invention pertains. In addition, terms, such as those defined in commonly used dictionaries, should be interpreted as having meanings that are consistent with their meanings in the context of the relevant art and should not be interpreted in an idealized or overly formal sense unless clearly defined.

It should be understood that terms such as “include” and “have” specify the presence of stated features, numbers, steps, operations, components, parts, or groups thereof but do not preclude the presence or addition of one or more other features, numbers, steps, operations, components, parts, or groups thereof.

Hereinafter, embodiments of the present invention will be described in detail with reference the accompanying drawings.

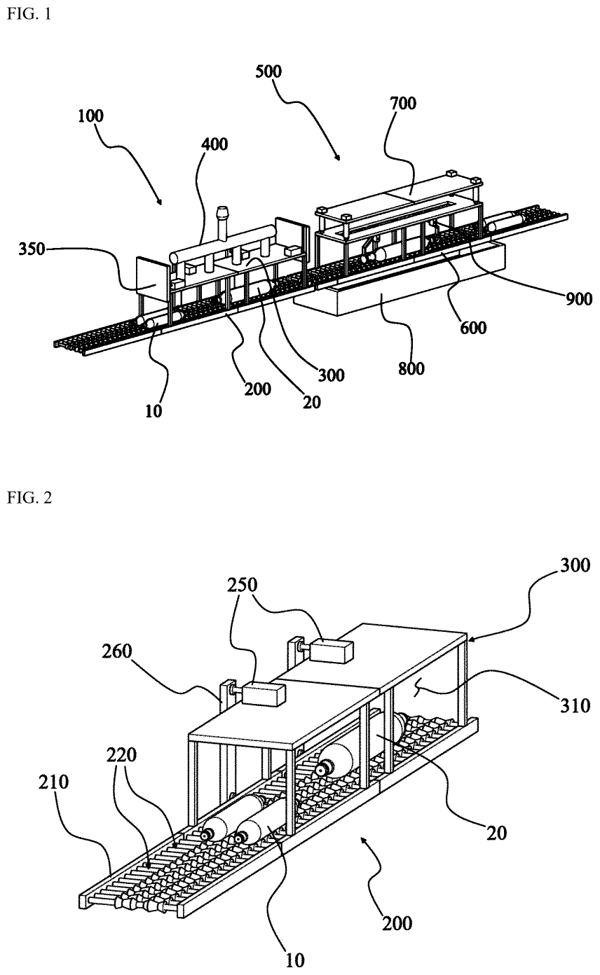

FIG. 1 is a view illustrating the overall form of the continuous heat treatment system for a high-pressure fluid storage container according to one embodiment of the present invention.

As illustrated in FIG. 1, the continuous heat treatment system for a high-pressure fluid storage container according to one embodiment of the present invention mainly includes a heat treatment apparatus 100 and a cooling apparatus 500.

In the system illustrated in FIG. 1, it is illustrated that one heat treatment apparatus 100 and one cooling apparatus 500 are provided, however, the heat treatment apparatus 100 and the cooling apparatus 500 may be provided as a plurality of heat treatment apparatuses 100 and a plurality of cooling apparatuses 500, and the plurality of heat treatment apparatuses 100 and the plurality of cooling apparatuses 500 may be disposed alternately.

In addition, specifically, the heat treatment apparatus 100 includes a heat treatment furnace 300, a first transfer unit 200, a heating unit 400, and insulating units 350.

In addition, specifically, the cooling apparatus 500 includes a second transfer unit 600, a lifting driving unit 700, a cooling bath 800, and chocking units 900.

Hereinafter, each component will be described in detail.

FIGS. 2 to 5 are views illustrating forms and structures of components provided in the heat treatment apparatus 100 in the continuous heat treatment system for a high-pressure fluid storage container according to one embodiment of the present invention.

As illustrated in FIGS. 2 to 5, a heat treatment space 310 is formed in the heat treatment furnace 300. The heat treatment furnace 300 may be formed in the form of a chamber having a shielded interior, but in the drawings, it is illustrated with an open side surface to show the structure thereof.

The first transfer unit 200 transfers high-pressure fluid storage containers 10 and 20, in which high-pressure fluid is stored, through the heat treatment space 310 in a longitudinal direction.

Specifically, the first transfer unit 200 includes a plurality of transfer roller modules 220 disposed along a transfer path of the high-pressure fluid storage containers 10 and 20, transfer frames 210 that secure both sides of the transfer roller modules 220, and driving motors 250 that provide rotational driving forces to the transfer roller modules 220.

Particularly, in the present embodiment, in the first transfer unit 200, the driving motors 250 may be provided outside the heat treatment furnace 300, and the first transfer unit 200 may further include driving force transmission modules 260 for transmitting the rotational driving forces of the driving motors 250 to the transfer roller modules 220.

In this case, the transfer roller modules 220 may be connected through a chain or the like so that the transfer roller modules 220 rotate in conjunction with each other, and each of the driving force transmission modules 260 may be formed in the form of a driving force transmission belt that transmits a rotational driving force of each of the driving motors 250 to any one of the transfer roller modules 220.

Accordingly, the rotational driving force of the driving motor 250 is transmitted to all the transfer roller modules 220, and the first transfer unit 200 may move the high-pressure fluid storage containers 10 and 20 in a downstream direction through the transfer roller modules 220.

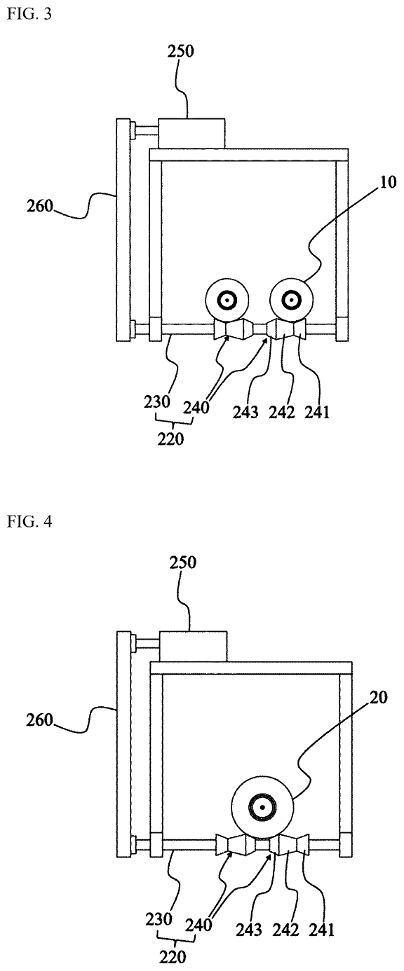

In addition, as illustrated in FIGS. 3 and 4, the transfer roller modules 220 include rotating bars 230, which rotate about central axes due to the rotational driving forces of the driving motors 250, and support rollers 240, which are provided to surround circumferences of the rotating bars 230, rotate with the rotating bars 230, and support the high-pressure fluid storage containers 10 and 20.

In this case, a pair of support rollers 240 may be line-symmetrically provided on each of the rotating bars 230 to be spaced apart from each other and transfer all high-pressure fluid storage containers 10 and 20 having different specifications.

Hereinafter, for convenience of description, a relatively small high-pressure fluid storage container is called a first high-pressure fluid storage container 10, and a relatively large high-pressure fluid storage container is called a second high-pressure fluid storage container 20.

In the present embodiment, each of the support rollers 240 includes a first support part 241, which supports one eccentric side portion of the first high-pressure fluid storage container 10, and a second support part 242, which is connected to the first support part 241 and supports the other eccentric side portion of the first high-pressure fluid storage container 10.

In this case, the first support part 241 and the second support part 242 may have inclined surfaces inclined downward toward a connection point thereof to form a recessed groove so as to stably support the first high-pressure fluid storage container as illustrated in FIG. 3.

In addition, the pair of support rollers 240 may further include third support parts 243, which protrude downward in opposite directions to support one eccentric side portion and the other side portion of the second high-pressure fluid storage container having specifications different from those of the first high-pressure fluid storage container 10, which is supported by the first support part 241 and the second support part 242.

That is, a pair of support rollers 240 that are linearly symmetrical may stably support the second high-pressure fluid storage container 20 using the third support parts 243 thereof as illustrated in FIG. 4.

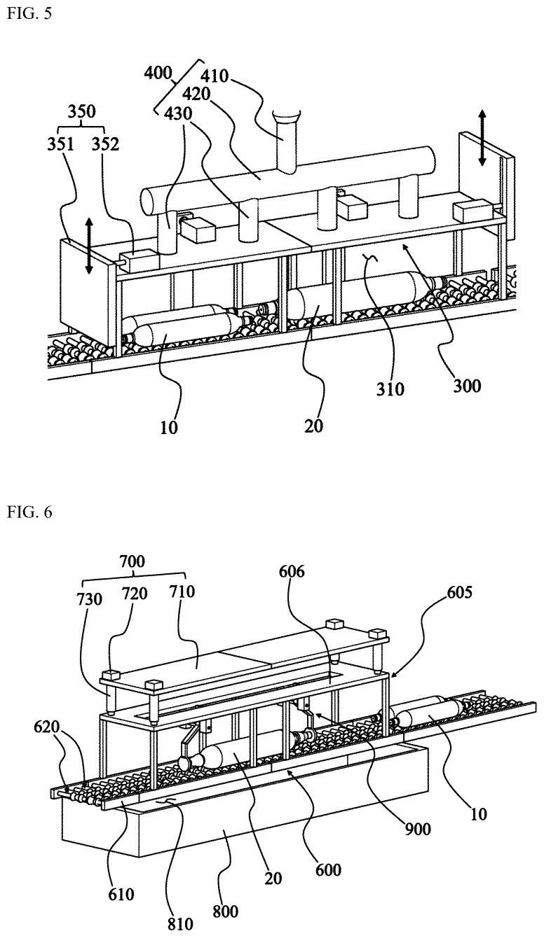

In addition, as illustrated in FIG. 5, the heating unit 400 is provided to heat an interior of the heat treatment space 310 to a predetermined heat temperature atmosphere.

In the present embodiment, the heating unit 400 is provided on the heat treatment furnace 300 and has a structure including a main supply pipe 410, which supplies high-temperature air from a heat source, a diffusion pipe 420, which diffuses the high-temperature air from the main supply pipe 410 in a horizontal direction, and branched pipes 430, which supply the high-temperature air to the heat treatment space 310 from different locations of the pipe 420.

The structure and the shape of the heating unit 400 are not limited to the present embodiment.

In addition, the insulating units 350 are provided at an entrance and an exit of the heat treatment furnace 300 and serve to selectively block the entrance and exit of the heat treatment furnace 300.

Specifically, in the present embodiment, the insulating units 350 include insulating doors 351 provided to selectively block the entrance and exit of the heat treatment furnace 300 and door lifting motors 352, which provide driving forces for vertically moving the insulating doors 351.

That is, the insulating units 350 block the entrance and exit of the heat treatment furnace 300 using the insulating doors 351 while a heat treatment process is performed and raise the insulating doors 351 to open the entrance and exit of the heat treatment furnace 300 in a process of transferring the high-pressure fluid storage containers 10 and 20.

Next, FIGS. 6 to 8 are views illustrating forms and structures of components provided in the cooling apparatus 500 in the continuous heat treatment system for a high-pressure fluid storage container according to one embodiment of the present invention.

As illustrated in FIGS. 6 to 8, the second transfer unit 600 continuously transfers the high-pressure fluid storage containers 10 and 20 transferred from the first transfer unit 200 in the longitudinal direction, and a lifting part 605 is formed in a partial section to be vertically moved in a state in which the high-pressure storage containers 10 and are held.

The lifting part 605 may be formed in the partial section independently divided from an entire section of the second transfer unit 600. In addition, in the present embodiment, a lifting frame 606 is provided on the lifting part 605.

In addition, since detailed structures of a transfer frame 610, a transfer roller module 620, and the like of the second transfer unit 600 are the same as those of first transfer unit 200 described above, the detailed descriptions thereof will be omitted.

In this case, the driving motor 250 of the first transfer unit 200 and a driving motor (not shown) of the second transfer unit 600 may be formed to be synchronized with each other to control a speed.

The chocking units 900 are disposed to block open ends of the high-pressure fluid storage containers 10 and 20 before the high-pressure fluid storage containers 10 and located in the lifting part 605 are lowered by the lifting part 605.

This is to prevent a cooling fluid from entering the high-pressure fluid storage containers 10 and 20 during a cooling process described below.

Since small holes are formed in both ends of the high-pressure fluid storage containers 10 and 20, and flames are being ejected from each hole in a state in which the high-pressure fluid storage containers 10 and 20 are transferred from the heat treatment apparatus 100, when the cooling process is performed without performing a blocking process using the chocking units 900, there is the possibility that an accident can occur due to the flames and an explosion can occur due to rapid evaporation of the cooling fluid.

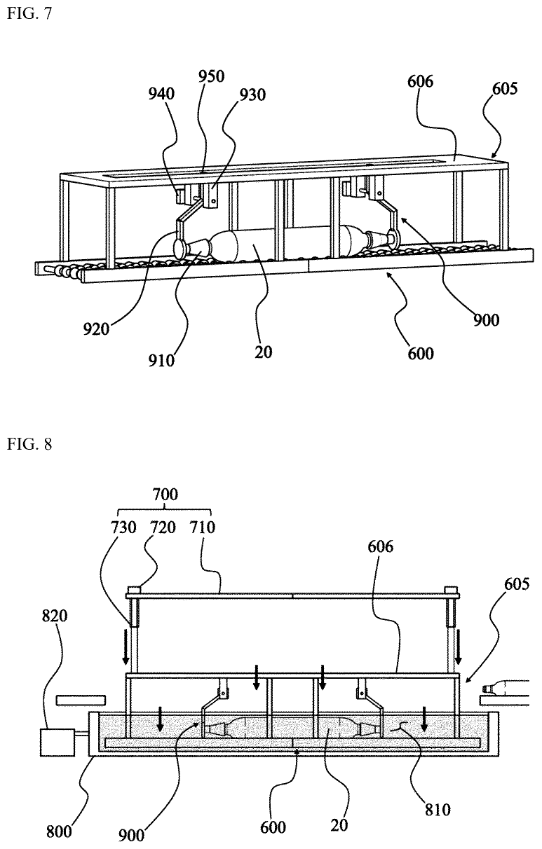

As illustrated in FIG. 7, the chocking units 900 may include blocking members 910, which are provided to selectively block the open ends of the high-pressure fluid storage containers 10 and 20 and in which air paths through which air flows are formed, rotational connecting members 920 connected to the blocking members 910 to rotate the blocking members 910 along circular trajectories about rotation axes at predetermined locations, rotary motors 940 for providing rotational driving forces to the rotational connecting members 920, fixing members 930 for rotatably fixing the rotational connecting members 920, and an air injection module (not shown) for preventing the cooling fluid from flowing into the high-pressure fluid storage containers 10 and 20 by injecting air into the air paths of the blocking members 910.

A pair of chocking units 900 may be provided in a line-symmetrical form to correspond to both sides of the high-pressure fluid storage containers 10 and 20, and since a location of one of the chocking units 900 at one side should vary according to a length of each of the high-pressure storage containers 10 and 20, one of the chocking units 900 may be formed to be transported in the longitudinal direction.

To this end, in the present embodiment, the chocking units 900 may further include slide members 950 connected to the fixing members 930 and transported along a guide rail formed in the lifting frame 606.

In addition, as illustrated in FIG. 8, the lifting driving unit 700 is provided to vertically move the lifting part 605.

In the present embodiment, the lifting driving unit 700 includes a fixing frame 710 provided above the lifting part 605, length adjusting modules 730 provided under the fixing frame 710, connected to the lifting part 605, and whose lengths are variable, and lifting motors 720, which provide driving forces for adjusting the lengths of the length adjusting modules 730.

In this case, the length adjusting modules 730 may include cylinders and pistons, and a method in which the pistons are linearly moved by driving forces of the lifting motors 720 may be applied to the length adjusting modules 730, but the present invention is not limited thereto.

Due to the lifting driving unit 700, the lifting part 605 is formed to vertically move the high-pressure fluid storage containers 10 and 20 and enters a cooling space 810 of the cooling bath 800 located at a lower portion thereof along with the high-pressure fluid storage containers 10 and 20 when the lifting part 605 moves downward. A predetermined cooling fluid may be accommodated in the cooling space 810.

That is, the high-pressure fluid storage containers 10 and 20 located in the cooling space 810 due to the lowering of the lifting part 605 may be cooled by the cooling fluid, and after the cooling process, a transfer process may be performed by the second unit transfer unit 600 in a state in which the lifting part 605 is raised and returns to its original location.

When a method of lowering only the high-pressure fluid storage containers 10 and 20 into the cooling bath 800 in the lower portion thereof is used without applying the vertical movement method of the lifting part 605, an accident can occur when the high-pressure fluid storage containers 10 and 20 are input thereto, and there is a risk the cooling fluid scattering.

Meanwhile, in the present embodiment, the cooling apparatus 500 may further include a circulation pump unit 820, which circulates the cooling fluid accommodated in the cooling bath 800 in a direction parallel to a transfer direction of the high-pressure fluid storage containers 10 and 20.

The reason for providing the circulation pump unit 820 as described above is to maintain a temperature of the cooling fluid as constant as possible by circulating the cooling fluid in the longitudinal direction so that the temperature of the cooling fluid is uniformly maintained for uniform heat treatment of the high-pressure fluid storage containers 10 and 20 in the narrow and long cooling bath 800.

In the present invention described above, since the high-pressure fluid storage containers 10 and 20 pass through the heat treatment furnace 300 and the cooling bath 800 in the process of continuously transferring the high-pressure fluid storage containers 10 and 20 using the first transfer unit 200 and the second transfer unit 600, the heat treatment process and the cooling process can be consecutively performed, and thus an overall process time can be reduced and productivity can be significantly improved.

In addition, according to the present invention, quality variations can be minimized by greatly reducing a product processing waiting time, and since a process of moving the high-pressure fluid storage containers 10 and 20 to separate locations is omitted, an accident can be fundamentally prevented.

The exemplary embodiments of the present invention have been described as described above, and it may be clear to those skilled in the art that the present invention may be embodied in other specific forms without departing from its purpose and scope in addition to the above-described embodiments. Therefore, the above-described embodiments should be regarded as illustrative and not restrictive, and accordingly, the present invention is not limited to the above description and may be modified within the scope of the appended claims and their equivalents.

### REFERENCE NUMERALS

10, 20: HIGH-PRESSURE FLUID STORAGE CONTAINER
100: HEAT TREATMENT APPARATUS
200: FIRST TRANSFER UNIT
210: TRANSFER FRAME
220: TRANSFER ROLLER MODULE
230: ROTATING BAR
240: SUPPORT ROLLER
241: FIRST SUPPORT PART
242: SECOND SUPPORT PART
243: THIRD SUPPORT PART
250: DRIVING MOTOR
260: DRIVING FORCE TRANSMISSION MODULE
300: HEAT TREATMENT FURNACE
310: HEAT TREATMENT SPACE
350: INSULATING UNIT
351: INSULATING DOOR
352: DOOR LIFTING MOTOR
400: HEATING UNIT
410: MAIN SUPPLY PIPE
420: DIFFUSION PIPE
430: BRANCHED PIPE
500: COOLING APPARATUS
600: SECOND TRANSFER UNIT
605: LIFTING PART
606: LIFTING FRAME
610: TRANSFER FRAME
620: TRANSFER ROLLER MODULE
700: LIFTING DRIVING UNIT
710: FIXING FRAME
720: LIFTING MOTOR
730: LENGTH ADJUSTING MODULE
800: COOLING BATH
810: COOLING SPACE
820: CIRCULATION PUMP UNIT
900: CHOCKING UNIT
910: BLOCKING MEMBER
920: ROTATIONAL CONNECTING MEMBER
930: FIXING MEMBER
940: ROTARY MOTOR
950: SLIDE MEMBER

1. A continuous heat treatment system for a high-pressure fluid storage container, comprising:
a heat treatment apparatus including a heat treatment furnace in which a heat treatment space is formed, a first transfer unit which transfers a high-pressure fluid storage container, in which a high-pressure fluid is stored, in a longitudinal direction through the heat treatment space, and a heating unit which heats an interior of the heat treatment space to a predetermined heat treatment temperature atmosphere; and
a cooling apparatus including a second transfer unit which continuously transfers the high-pressure fluid storage container transferred from the first transfer unit in the longitudinal direction and in which a lifting part is formed in at least a partial section to be vertically moved in a state in which the high-pressure fluid storage container is held, a lifting driving unit which vertically moves the lifting part, and a cooling bath in which a cooling space for accommodating a cooling fluid is formed and which is provided under the second transfer unit to cool the high-pressure fluid storage container located in the cooling space as the lifting part is lowered.

2. The continuous heat treatment system of claim 1, wherein the heat treatment apparatus and the cooling apparatus are provided as a plurality of treatment apparatuses and a plurality of cooling apparatuses, which are alternatively disposed.

3. The continuous heat treatment system of claim 1, wherein the first transfer unit and the second transfer unit include:
a plurality of transfer roller modules disposed along a transfer path of the high-pressure fluid storage container; and
driving motors which provide rotational driving forces to the transfer roller modules.

4. The continuous heat treatment system of claim 3, wherein the driving motor of the first transfer unit and the driving motor of the second transfer unit are synchronized with each other to control a speed.

5. The continuous heat treatment system of claim 3, wherein:
the driving motor is provided outside the heat treatment furnace; and
the first transfer unit further includes a driving force transmission module which transmits the rotational driving force of the driving motor to the transfer roller module.

6. The continuous heat treatment system of claim 3, wherein the transfer roller module includes:
a driving bar rotated about a central axis by the rotational driving force of the driving motor; and
a support roller which is provided to surround a circumference of the rotating bar, rotates with the rotating bar, and supports the high-pressure fluid storage container.

7. The continuous heat treatment system of claim 6, wherein the support roller includes:
a first support part which supports one eccentric side portion of the high-pressure fluid storage container; and
a second support part which is connected to the first support part and supports the other eccentric side portion of the high-pressure fluid storage container,
wherein the first support part and the second support part are each formed to have an inclined surface inclined downward toward a connection point thereof to form a recessed groove.

8. The continuous heat treatment system of claim 7, wherein the support roller is provided as a pair of support rollers on the rotating bar to have a line-symmetrical form and be spaced apart from each other.

9. The continuous heat treatment system of claim 8, wherein the pair of support rollers further include third support parts which protrude in opposite directions and support one eccentric side portion and the other eccentric side portion of a high-pressure fluid storage container having specifications different from those of the high-pressure fluid storage container supported by the first support parts and the second support parts.

10. The continuous heat treatment system of claim 1, wherein the heat treatment apparatus further includes insulating units provided at an entrance and an exit of the heat treatment furnace to selectively block the entrance and exit of the heat treatment furnace.

11. The continuous heat treatment system of claim 10, wherein the insulating unit includes:
an insulating door provided to selectively block the entrance and exit of the heat treatment furnace; and
a door lifting motor which provides a driving force for vertically moving the insulating door.

12. The continuous heat treatment system of claim 1, wherein the cooling apparatus further includes a chocking unit which blocks an open end of the high-pressure fluid storage container before the high-pressure fluid storage container located in the lifting part is lowered by the lifting part.

13. The continuous heat treatment system of claim 12, wherein the chocking unit include:
a blocking member which is provided to selectively block the open end of the high-pressure fluid storage container and in which an air path through air flows is formed;
a rotational connecting member which is connected to the blocking member and rotates the blocking member along a circular trajectory about a rotation axis at a predetermined location;
a rotary motor which provides a rotational driving force to the rotational connecting member; and
an air injection module which prevents the cooling fluid from entering the high-pressure fluid storage container by injecting air into the air path of the blocking member.

14. The continuous heat treatment system of claim 1, wherein the lifting driving unit includes:
a fixing frame provided above the lifting part;
a length adjusting module provided under the fixing frame, connected to the lifting part, and whose length is variable; and
a lifting driving motor which provides a driving force for adjusting the length of the length adjusting module.

15. The continuous heat treatment system of claim 1, wherein the cooling apparatus further includes a circulation pump unit which circulates the cooling fluid accommodated in the cooling bath in a direction parallel to a transfer direction of the high-pressure fluid storage container.
